(19) United States
(12) Patent Application Publication
(10) Pub. No.: US 2010/0084036 A1
(43) Pub. Date: Apr. 8, 2010

(54) COMPOSITE PIPE DESIGNED TO TRANSPORT, INDISCRIMINATELY, A HYDROCARBON FUEL OR A HYDRAULIC FLUID

(75) Inventor: Christophe Le Morvan, Oissel (FR)

Correspondence Address: CASELLA & HESPOS, 274 MADISON AVENUE, NEW YORK, NY, 10016, US

(73) Assignee: AERAZUR, Issy Les Moulineaux (FR)

(21) Appl. No.: 12/573,924

(22) Filed: Oct. 6, 2009

(30) Foreign Application Priority Data
Oct. 7, 2008 (FR) 08 56772

(51) Int. Cl. F16L 9/14; B23P 17/00

(52) U.S. Cl. 138/109; 138/141; 29/527.2; 138/125; 138/153

(57) ABSTRACT

The present invention relates to a composite pipe (1) designed to transport, indiscriminately, a hydrocarbon fuel or a hydraulic fluid, characterized in that it comprises a hollow central sheath (10) made of a thermoformed thermoplastic and an external sheath (20) consisting of several radially superposed layers (22, 24) comprising at least one layer of resin (24) placed in direct contact with the central sheath (10) and one layer of fibers (22) covering the layer of resin (24).

### BACKGROUND OF THE INVENTION

1. Field of the Invention

The present invention relates to a composite pipe designed to transport, indiscriminately, a hydrocarbon fuel or a hydraulic fluid, particularly in the aeronautical field.

2. Description of the Related Art

At the present time, aircraft such as airplanes or helicopters comprise numerous lines for carrying fluid, whether these be fuels, such as hydrocarbons like kerosene, or a hydraulic fluid such as oil.

However, some of these lines are made of metal (stainless steel, aluminum, brass). There are therefore heavy, complicated and expensive to produce because of their sometimes complex shapes, and are difficult to install because they are fairly rigid.

It is therefore an object of the present invention to solve the aforementioned problems using a solution that is simple to implement, reliable and less expensive.

### SUMMARY OF THE INVENTION

Thus, the subject of the present invention is a composite pipe designed to transport, indiscriminately, a hydrocarbon fuel or a hydraulic fluid, characterized in that it comprises a hollow central sheath made of a thermoformed thermoplastic and an external sheath consisting of several radially superposed layers comprising at least one layer of resin placed in direct contact with the central sheath and one layer of fibers covering the layer of resin.

According to some preferred embodiments, the pipe according to the present invention further comprises at least one of the following features:
the external sheath consists of an alternation of layers of resin and of layers of fibers, and at least of one layer of fibers sandwiched between two layers of resin;
the central sheath is made of a thermoplastic chosen from the group consisting of polyamide (PA), polyoxy methylene (POM), polyether ether ketone (PEEK), polyester, polysulfone (PSU), polyphenylene sulfide (PPS), polyimide (PI), polyamide-imide (PAI) and polyvinylidene fluoride (PVDF) and other fluorides;
each layer of resin is made of epoxy, polyester, phenol or vinyl ester;
each layer of fibers is created on the basis of glass fiber, carbon fiber, Kevlar fiber or flax fiber, or a mixture of these fibers;
the central sheath is thermoformed to the desired shape, particularly in order to give it its final curvature;
couplings, for example of the “Y”, “T”, or “L” type, are connected to the ends of the pipe, particularly around the central sheath; and
the external layers encapsulate part of the couplings connected to the central sheath.

The present invention also relates to a method for creating a composite pipe designed to transport, indiscriminately, a hydrocarbon fuel or a hydraulic fluid, characterized in that it consists in encapsulating a hollow central sheath made of a thermoplastic using an external sheath consisting of several radially superposed layers and comprising at least one layer of resin placed in direct contact with the central sheath and a layer of fibers covering the layer of resin.

Advantageously, the central sheath is thermoformed beforehand, by hot bending, in order to give it its final curvature, before it is covered with the external sheath.

The invention also relates to the use of the pipe as described hereinabove to carry, indiscriminately, a hydrocarbon such as fuel oil or kerosene, or a hydraulic fluid such as oil, particularly in the aeronautical industry.

The invention will now be described in greater detail with reference to a particular embodiment which is given solely by way of illustration and depicted in the figures.

### BRIEF DESCRIPTION OF THE DRAWINGS

FIG. 1 is a cutaway perspective view of a pipe according to the present invention.

FIG. 2 is a sectional view depicting the pipe in its entirety, from one end to the other.

### DETAILED DESCRIPTION OF THE PREFERRED EMBODIMENT

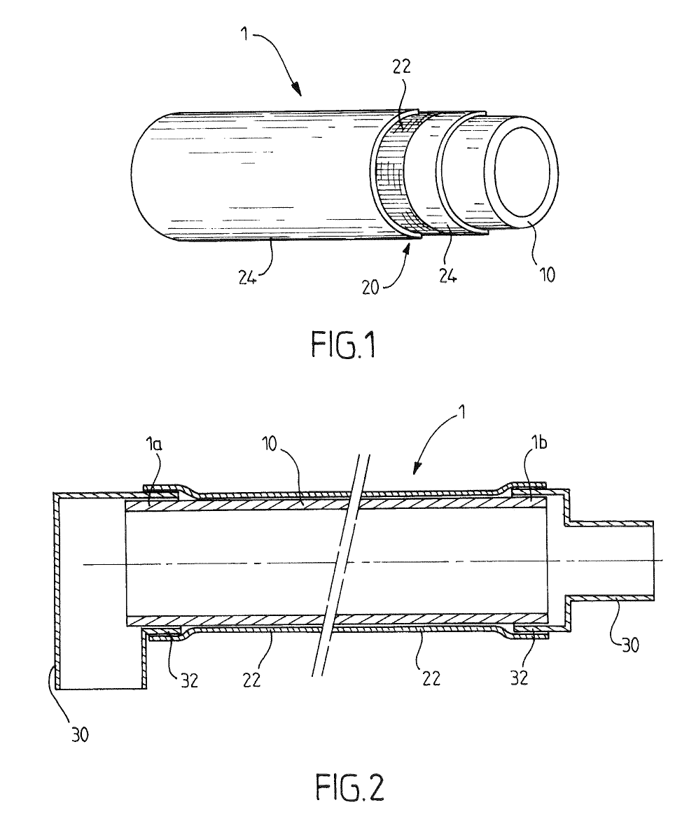

A pipe 1 for carrying fluid according to the present invention is depicted in FIG. 1.

This pipe 1 comprises a hollow central sheath 10, or primary tube, made of thermoformed thermoplastic, and an external sheath 20 made up of several radially superposed layers.

More specifically, the external layer 20 consists of an alternation of layers of resin and of fibers, and at least of one layer of fibers 22 sandwiched between two layers of resin 24 one of which is closely associated with the central sheath.

As far as the choice of materials is concerned, the central sheath 10 is made of a thermoplastic chosen from the group consisting of polyamide (PA), polyoxy methylene (POM), polyether ether ketone (PEEK), polyester, polysulfone (PSU), polyphenylene sulfide (PPS), polyimide (PI), polyamide-imide (PAI) and polyvinylidene fluoride (PVDF) and other fluorides.

Each layer of resin 24 is made of epoxy and each layer of fibers 22 is created on the basis of glass fiber, carbon fiber or Kevlar fiber.

In order to give it its finished shape, particularly its curvature, the invention also relates to the fact that during the method of producing the pipe, the central sheath 10 is thermoformed by hot bending to the desired shape before it is covered with the external sheath 20.

Couplings 30, for example of the “Y”, “T”, or “L” type, are connected to the ends 1a and 1b of the pipe 1, particularly around the central sheath 10. More specifically, as depicted in FIG. 2, the external layers, particularly the first layer of resin 24, encapsulate part 32 of the couplings 30 connected to the central sheath 10.

Such a pipe 1 can thus be used, through its design, to carry, indiscriminately, a hydrocarbon such as fuel oil or kerosene or hydraulic fluid such as oil, particularly in the aeronautical industry.

A pipe such as this measures, for example, from 12 mm to 130 mm and operates in a temperature range extending from −55° C. to +125° C. at a pressure ranging from negative pressures to several thousand Psig.

It goes without saying that the detailed description of the subject matter of the invention, given purely by way of illustration, does not in any way constitute a restriction, technical equivalents also being included within the scope of the present invention.

Thus, other materials may be used for other uses. In particular, each layer of resin may be a polyester, phenolic or vinyl ester resin. Likewise, the layer of fibers may be based on carbon, Kevlar, flax or mixtures of these fibers.

What is claimed is:

1. A composite pipe (1) designed to transport, indiscriminately, a hydrocarbon fuel or a hydraulic fluid, comprising a hollow central sheath (10) made of a thermoformed thermoplastic and an external sheath (20) having several radially superposed layers (22, 24) comprising at least one layer of resin (24) placed in direct contact with the central sheath (10) and one layer of fibers (22) covering the layer of resin (24), the central sheath (10) being thermoformed to a desired shape and to give the central sheath (10) a specified final curvature.

2. The pipe of claim 1, characterized in that the external sheath comprises an alternation of layers of resin (24) with at least one layer of fibers (22), so that the at least one layer of fibers (22) is sandwiched between two layers of resin (24).

3. The pipe of claim 2, characterized in that the central sheath (10) is made of a thermoplastic chosen from the group consisting of polyamide (PA), polyoxy methylene (POM), polyether ether ketone (PEEK), polyester, polysulfone (PSU), polyphenylene sulfide (PPS), polyimide (PI), polyamide-imide (PAI) and polyvinylidene fluoride (PVDF) and other fluorides.

4. The pipe of claim 2, characterized in that each layer of resin (24) is made of epoxy, polyester, phenol or vinyl ester.

5. The pipe of claim 1, characterized in that the layer of fibers (22) is created on the basis of glass fiber, carbon fiber, Kevlar fiber or flax fiber, or a mixture of these fibers.

6. The pipe of claim 1, further comprising couplings (30) connected to the ends (1a, 1b) of the pipe (1) around parts of the central sheath (10).

7. The pipe of claim 6, characterized in that the external layers (22, 24) encapsulate part (32) of the couplings (30) connected to the central sheath (10).

8. A method for creating a composite pipe (1) designed to transport, indiscriminately, a hydrocarbon fuel or a hydraulic fluid, consisting in encapsulating a hollow central sheath (10) made of a thermoplastic using an external sheath (20) having several radially superposed layers (22, 24) and comprising at least one layer of resin (24) placed in direct contact with the central sheath (10) and a layer of fibers (22) covering the layer of resin (24), characterized in that the central sheath (10) is thermoformed beforehand, by hot bending to give the central sheath (10) a final curvature, before the central sheath (10) is covered with the external sheath (20).
